(19) United States
(12) Patent Application Publication
(10) Pub. No.: US 2025/0292101 A1
(43) Pub. Date: Sep. 18, 2025

(54) FOOD: Effective Detection of Out-of-Distribution Inputs in Neural Networks

(71) Applicant: Northeastern University, Boston, MA (US)

(72) Inventors: Francesco Restuccia, Boston, MA (US); A Q M Sazzad Sayyed, Quincy, MA (US); Shahriar Rifat, Westbrook, ME (US)

(21) Appl. No.: 19/080,274

(22) Filed: Mar. 14, 2025

Related U.S. Application Data
(60) Provisional application No. 63/566,136, filed on Mar. 15, 2024.

(51) Int. Cl. G06N 3/094

(52) U.S. Cl. CPC G06N 3/094

(57) ABSTRACT

A method of detecting an out-of-distribution input to a deep neural network (DNN) comprises perturbing a sample input, de-noising the perturbed sample input, and extracting gradient projection features of the sample input from each layer of the DNN, and concatenating the one or more gradient projection features of the sample input from the layers of the DNN into a feature vector for the sample input. The method comprises extracting gradient projection features of the de-noised sample input from each layer of the DNN, and concatenating the gradient projection features of the de-noised sample input from the layers of the DNN into a single feature vector for the denoised sample input. The method comprises generating a projected density score based on the feature vector for the sample input and the single feature vector the de-noised sample input and determining that the sample input is out-of-distribution when the score exceeds a threshold.

### RELATED APPLICATION

This application claims the benefit of U.S. Provisional Application No. 63/566,136, filed on Mar. 15, 2024. The entire teachings of the above application are incorporated herein by reference.

### GOVERNMENT SUPPORT

This invention was made with government support under Grant No. FA9550-23-1-0261 from the Air Force Office of Scientific Research. The government has certain rights in the invention.

### BACKGROUND

A Deep Neural Network (DNN) is vulnerable to different intentional and unintentional perturbations to inputs. One approach to be robust against such perturbation is to use robust training, which still has its limitations as it relies primarily on augmentations and fails when samples from different distributions other than the training distribution (out-of-distribution) are presented to the DNN. One solution to this problem is to detect such out-of-distribution samples and take appropriate actions for them. Existing techniques treat intentional perturbation, a.k.a. adversarial perturbation, and unintentional perturbation, a.k.a. corruption, as two separate entities and no work attempts at unified detection of these perturbations.

### SUMMARY

Deep Neural Networks (DNNs) are known to exhibit loss of performance in the presence of Out-of-Distribution (OOD) inputs. The latter may due to (i) semantic shift (due to the presence of a new class), (ii) non-semantic shift (due to unintentional perturbations) and (iii) intentional perturbation (due to adversarial inputs). As yet, there is no comprehensive framework that detects the three types of OOD inputs at once. Described herein is a novel approach “FOOD: Framework for Out-of-Distribution Detection,” based on a difference between the characteristics of a loss-manifold for perturbed inputs and unperturbed ones. Example embodiments of the invention disclosed herein measure these characteristics with a gradient of a loss function with respect to weights of the DNN. We show that FOOD outperforms the state-of-the-art approaches in terms of false positive rate by 7.97% on CIFAR10, 14.61% on CIFAR100, and 5.29% on Imagenet, and by 41.38% on CIFAR10 and 40.34% on CIFAR100 and 6.59% on ImageNet in the case of unintentional perturbations.

Further details and example embodiments are disclosed hereinbelow and in a manuscript being filed herewith, entitled “FOOD: Effective Detection of Out-of-Distribution Inputs in Neural Networks,” the teachings of which are incorporated herein by reference in their entirety.

### BRIEF DESCRIPTION OF THE DRAWINGS

The foregoing will be apparent from the following more particular description of example embodiments, as illustrated in the drawings interspersed in the manuscript being filed herewith. The drawings are not necessarily to scale, emphasis instead being placed upon illustrating embodiments.

FIG. 1 shows an overview of the described embodiments.

FIG. 2 shows that the stronger the added noise, the more adversarial samples change their labels.

FIG. 3 shows possible scenarios after de-noising.

FIG. 4 shows TSNE Visualization for unperturbed, intentionally perturbed and unintentionally perturbed inputs for Imagenet benchmark and Mobilenet V3 (Large) DNN.

FIG. 5A-F shows the probability density of scores in the case of CIFAR10 and ResNet56.

FIG. 6 shows that the FPR stabilizes around about 70% of the feature-length N_{f}.

FIG. 7 is a diagram of an example internal structure of a processing system that may be used to implement one or more of the described embodiments.

### DETAILED DESCRIPTION

A description of example embodiments follows.

The embodiments described herein are directed to out-of-distribution (OOD) sample detection and mitigation techniques in deep neural networks (DNNs).

DNNs are widely used in fields that include, for example, healthcare, wireless communications, and education. The ability of DNNs to automate complex tasks such as object detection, language translation, image classification, and efficient pose estimation has put DNNs among the most critical Artificial Intelligence (AI) technologies. At the same time, the tremendous benefits brought by DNNs come with significant safety and security issues. A key assumption is that DNNs are confident with in-distribution (ID) samples, i.e., samples that come from its training distribution—and less confident with out-of-distribution (OOD) samples, i.e., samples that come from outside of its training distribution. This assumption is not the case in many real-world scenarios, where intentional and unintentional perturbations may affect the input distribution.

Ideally, instead of generating highly-confident erroneous decisions, a DNN should detect OOD inputs and “refuse” to provide decisions on the OOD data. It has been shown, however, that DNNs can assign class labels even to inputs which are just artificially generated noise and that too with confidence value of more than 90%. It is also well known that DNNs are highly susceptible to adversarial samples and inputs affected by various impairments (e.g., fog, blur, etc.). In addition, a DNN may encounter new classes of samples, which may also lead to erroneous decisions while the input should be tagged as an OOD sample. Accordingly, two types of OOD samples may be considered—semantic OOD and non-semantic OOD. Semantic OOD consists of classes not encountered during training, while non-semantic OOD represents inputs with a shift in the distribution due to unintentional perturbations. It has been demonstrated that existing OOD detection methods often cannot perform well on both OOD types. The described embodiments further consider intentional perturbations, also known as adversarial samples. Intentional perturbations are fundamentally different from unintentional perturbations, as they are directed to input samples with the intention of generating incorrect predictions.

Existing work presents a set of key limitations that makes it inapplicable to address both intentional and unintentional perturbations at once. For example, one of the early solutions for OOD detection uses Maximum Softmax Probability (MSP) score representing confidence of the DNN in its prediction to differen-tiate ID from OOD samples. However, it has been proven that DNN can show similar level of confidence for both ID and OOD samples. Moreover, it is known that the softmax-probability does not always correspond to confidence of DNN in its prediction. Intentionally perturbed samples, although not from the source or training distribution, still show high confidence for wrong classes. For detection of intentional perturbations, one of the earliest approaches uses layer-wise statistics to differentiate between natural and adversarially perturbed inputs.

A joint detection of adversarial and OOD samples has been proposed, but only considering semantic OOD. More recent approaches utilize features across different layers to detect intentional perturbation but utilizing information from adversarial domain to set design parameters, which makes these approaches not suitable for OOD detection as OOD data may not be available during training.

The described embodiments utilize a unified framework that can detect all types of OOD samples defined previously. A key intuition associated with the described embodiments is that intentionally and unintentionally perturbed inputs reside in a manifold separate from the manifold of unperturbed inputs. As such, if one can cause such a perturbed input to change the manifold, the corresponding change in the characteristics of the manifold (e.g. gradient, curvature) can be utilized to detect the sample as perturbed or OOD sample. Based on this intuition, we propose a general framework for OOD detection where we introduce a new approach where we employ gradient-based characterization of manifold as well as controlled additive Gaussian noise to detect change in manifold characteristics.

The embodiments described herein are based on a comprehensive Framework for Out-Of-Distribution Detection (referred to herein as ‘FOOD’), which is tailored to address OOD detection of (i) unintentional perturbation, (ii) intentional perturbation and (iii) semantic shift. As will be shown herein, the characteristics of the loss manifold changes depending on the distribution from which the input sample is drawn. Such change is characterized by using the gradient of the loss function with respect to the DNN weights. FOOD intentionally perturbs the input, performs perturbation-agnostic de-noising, and measures the resulting change in the gradient of the loss manifold.

FOOD has been compared against the state-of-the-art methods LID [Houle, M. E.: Local intrinsic dimensionality i: An extreme-value-theoretic foundation for similarity applications. In: Similarity Search and Applications (2017)], Mahalanobis [Lee, K., Lee, K., Lee, H., Shin, J.: A simple unified framework for detecting out-of-distribution samples and adversarial attacks. Advances in neural information processing systems 31 (2018)], Perturbed Log Odds [Roth, K., Kilcher, Y., Hofmann, T.: The odds are odd: A statistical test for detecting adversarial examples. In: International Conference on Machine Learning. pp. 5498-5507. PMLR (2019)], Random Subspace [Drenkow, N., Fendley, N., Burlina, P.: Attack agnostic detection of adversarial examples via random subspace analysis. In: Proceedings of the IEEE/CVF Winter Conference on Applications of Computer Vision. pp. 472-482 (2022)], HAMPER [Picot, M., Granese, F., Staerman, G., Romanelli, M., Messina, F., Piantanida, P., Colombo, P.: A halfspace-mass depth-based method for adversarial attack detection. Transactions on Machine Learning Research (2023)]. Different versions of the ResNet and MobileNet DNNs were considered, trained on CIFAR10, CIFAR100, and ImageNet datasets. On average, FOOD outperforms the other approaches by up to 7.97% in CIFAR10, 14.61% in CIFAR100, and 5.29% in ImageNet benchmark for intentional perturbations BIM, PGD, Autoattack, and C&W. This approach improves up to 41.38% in CIFAR10 and 44% in CIFAR100 benchmark for detection of unintentional perturbations (Gaussian noise, impulse noise, shot noise, defocus blur, motion blur, and frost) with respect to state of the art approaches MSP, Energy, ReAct, GradNorm, and Ash-B.

Early work proposes to use the softmax output probability to detect OOD. Similarly, ODIN proposes a temperature-scaled softmax score with input pre-processing. Mahalanobis uses class-conditional Gaussian distributions to represent the different classes. These approaches assume access to OOD data for determining optimum hyperparameters, which is not entirely realistic. Generalized ODIN (GODIN) extends upon ODIN by decoupling the softmax output into the joint distribution of label and domain, and the distribution of the domain. Another approach utilizes the similarity between the Helmholtz free energy equation and the softmax function. It has been shown that a modified cross-entropy loss with normalized logits can help OOD detection.

Decoupling MaxLogit (DML) improves the logit-based approach by decomposing it into MaxCosine and MaxNorm. Gradient Norm (GradNorm) first shows the use of gradient information can help detection of OOD samples. However, these approaches require change in training algorithm to obtain reasonable performance in perturbation detection. Conversely, the approach of the described embodiments requires no such changes, which makes it compatible with any training algorithm. Rectified Activation (ReAct) shows that the activation distribution of the penultimate layer shows very high activation values for OOD samples. It also shows that clamping the activation values to an upper bound c is beneficial to OOD detection. Activation Shaping by Binarizing (ASH-B) shows that simple shaping of the activation can affect the ID and OOD data differently. Three different methods are proposed for shaping the activation, namely—L₂ norm-based weight pruning, binarizing, and scaling. Among these techniques, the binarizing approach shows better results. However, these approaches capture semantic shift in the input, and cannot detect non-semantic OOD where no such semantic shift occurs. Moreover, these approaches do not consider intentional perturbation. To address these issues, FOOD uses features at the manifold level, which are common to all of the three types of OOD samples.

One of the earliest approaches characterizes the manifold of an input sample using its Local Intrinsic Dimensionality (LID). The assumption is that adversarial samples reside in a manifold different than natural input manifold, which ultimately increases the dimensionality of the adversarial manifold leading to easier detection. Similarly, another approach uses kernel density estimation to characterize the manifold of legitimate and adversarial examples from the last hidden layer of the DNN. However, this approach requires use of dropout in DNN which limits its applicability. Yet another approach proposes a statistical test based on Maximum Mean Discrepancy (MMD) to detect adversarial samples. This approach requires a minimum number of adversarial samples and cannot perform single sample detection. Another approach uses noise as probes for detection of adversarial samples. A fundamental difference between the embodiments described herein and this ‘noise as probes’ approach is that through adding noise and afterwards performing de-noising, the described embodiments capture any significant shift in the position of the input on loss manifold that may occur, while the ‘noise as probes’ approach extracts statistics from the noisy versions of the input for the purpose of detection. Another approach extracts random projections of the activation from different layers and creates prototypes for individual classes, while an alternative approach extracts halfspace mass depth score from each layer.

One key limitation of all these prior approaches is that they cannot detect unintentional OOD inputs. Moreover, they use information from adversarial examples to train the detectors, making them supervised approaches. The problem of supervised methods in adversarial sample detection is that (i) generation of adversarial examples to learn from is computationally expensive, and (ii) adversarial examples at test time may not come from the same distribution used at training time. In stark opposition, FOOD is perturbation-agnostic and learns only from the source distribution.

We cast our problem in the context of supervised multi-class classification. We represent a DNN as function F_{θ}(.) parameterized by θ. X represents the input random variable and x represents its particular realization. Probability distributions are denoted as P and their corresponding probability measures are denoted with P. We assume that given a source dataset D_{source}, if X=x∈D_{source}, then X˜P_{source}. We will use D_{source} and D_{id} interchangeably to denote source or ID dataset, and the same for P_{source} and P_{id}. We consider an input sample x to be OOD if it comes from one of the three distributions—distribution of intentionally perturbed inputs P_{adv}, distribution of unintentionally perturbed inputs P_{non-semantic}, and distribution of inputs with semantic shift P_{semantic}. We refer to P_{ood} to denote the three OOD distributions. Similarly, D_{adv}, D_{semantic}, D_{non-semantic}, and D_{ood} will denote dataset of adversarially perturbed inputs, dataset of inputs with semantic shift, dataset of unintentionally perturbed inputs, and OOD in general. As far as intentional interference is concerned, given a pre-trained DNN F_{θ}, and a dataset D_{source}={(xᵢ, yᵢ)}ᵢ₌₁^{i=N}, the most popular form of generating adversarial example is to craft perturbation δ:|δ1∥ₚ<∈, such that, F_{θ}(xᵢ+δ)≠yᵢ. Here, ∥·∥ₚ denotes the Lₚ norm.

We define the problem of OOD detection as a binary classification problem. Specifically, we aim to design a score function S(x) such that, S(x)˜P_{id}^{S} when x∈D_{id} and S(x)˜P_{ood}^{S} when x∈D_{ood}. Then the binary classification decision can be formulated as the finding the indicator function 1(\tilde{x}ᵢₙ) such that

$$𝟙 ( {\tilde{x}}_{in} ) = \{ \begin{matrix}1 , if S ( x ) < τ \\ 0 if S ( x ) > τ\end{matrix} \} \qquad ( 1 )$$

A value of 1 in the indicator function implies x˜P_{id} and a value of 0 means x·P_{ood}. The threshold r controls the performance of the binary classifier and trades off True Positive Rate (TPR) for lower False Positive Rate (FPR). Ideally, the distributions P_{id}^{S} and P_{ood}^{S} have zero overlap and the threshold r can be set such that 100% TPR can be achieved for 0% FPR. In practice, we aim to find the threshold that can achieve a certain TPR and measure the performance of the classifier with the obtained FPR value. Notice that Equation 1 implicitly assumes that the score for the ID samples is lower than the score for the OOD samples. Even if this is not the case, the score function can be inverted (multiplied with −1) to comply with Equation 1.

One of the motivating theories of the approach associated with he described embodiments is the manifold hypothesis for adversarial perturbation. The manifold hypothesis states that the adversarial samples are effective since they lie in a (possibly low-dimensional) manifold that is different from the source data distribution. Specifically, perturbed and unperturbed inputs may be differentiated by the distance between their manifolds. By constraining the legitimate inputs to have zero distance to the legitimate manifold, it can be demonstrated that adversarial examples show significant distance to the legitimate manifold. The manifold hypothesis may be extended to include semantic and non-semantic OOD data as well. We consider a manifold as defined by the optimal parameters θ*trained on dataset D_{source} [symbol] x=X˜P_{source}. We hypothesize that at least one of the following statements is true:
An input X=x˜P_{ood} resides at coordinate in a manifold different than the source data manifold. (Adversarial Manifold)
For an input X=x˜P_{ood} that resides at coordinate r_{ood} in the same manifold as the source data at coordinate r_{source} (and its neighborhood), the characteristics of such in-manifold OOD sample is different from that of the source sample. In other words, there exists a process A(r) which captures the characteristics of the manifold at coordinate r and A(r_{ood})≠A(r_{source}).

Based on this hypothesis, our task is then to design the process A(r) to capture the characteristics of the manifold at the coordinate of an input.

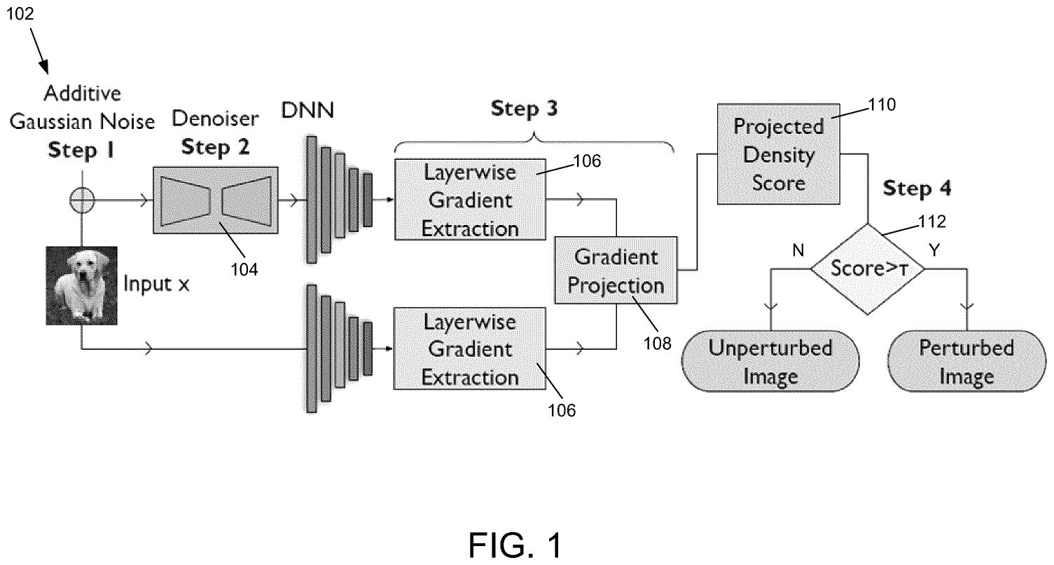

Use of augmentation for robustness of DNN against perturbation is a well-known approach. To improve robustness, an image-to-image network may be used that applies multiple augmentation to the input image. To decrease the computation burden, Gaussian noise is used to perturb the position of the input on the loss-manifold. Gaussian noise has been used for detection of adversarial perturbation where it has been shown that adding Gaussian noise can cause the feature representation of an adversarially perturbed input towards the unperturbed counterpart. In combination with the manifold hypothesis, adding Gaussian noise can cause an adversarial input to cross its manifold and arrive at the legitimate manifold. Adding Gaussian noise to OOD data with semantic shift or unintentional perturbation causes the data to shift their coordinates on the manifold. FIG. 1, along with the description below, provides an overview of the described embodiments.

Step #1: Perturbing with Gaussian Noise—A first step comprises perturbing 102 with Gaussian Noise. We first perturb 102 the input sample x with additive Gaussian noise with power σ². This can lead to one of the following scenarios:
1. If the input X=x˜P_{source}, then perturbing the input will shift its coordinate on the manifold towards the location of non-semantic OOD samples.
2. If the input X=x˜P_{adv}, with sufficiently strong perturbation, it will be stirred towards the legitimate input manifold.
3. If the input X=x˜P_{semantic} or x=X˜P_{non-semantic}, then the perturbation will shift its coordinate on the manifold in a random direction.

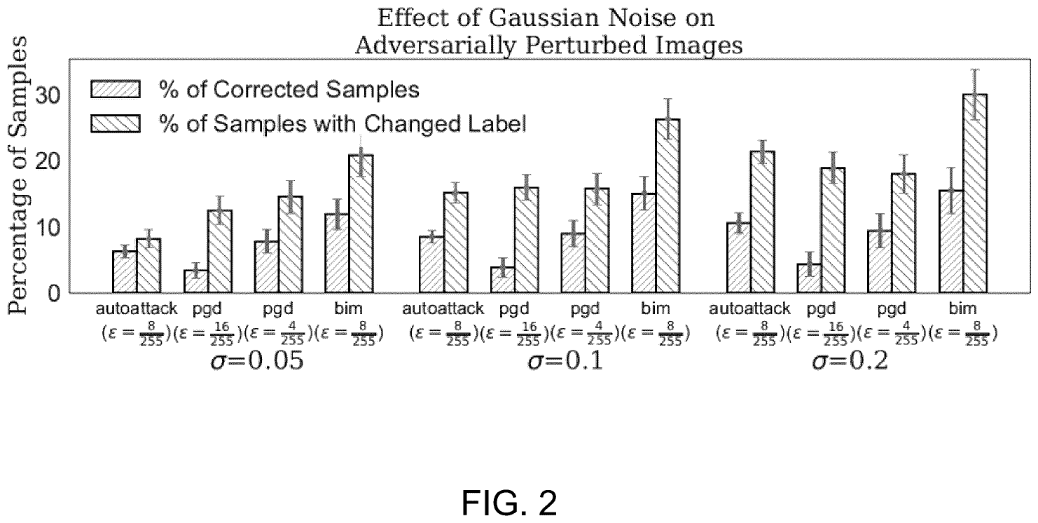

The effect of the change in coordinate on the manifold is observed directly as several adversarial inputs show changes in their predicted labels. Specifically, experimenting with CIFAR10 and ResNet56 model architecture, we observe that about 18% of the adversarial inputs (generated with steps PGD attack with perturbation budget of 16/225) change their label and about 16% of them are predicted correctly by the DNN after de-noising when perturbed with zero-mean Gaussian noise with 0.1 standard deviation. FIG. 2 demonstrates that the stronger the added noise, the more adversarial samples change their labels. This is also true for semantic and non-semantic OOD.

Two options are presented below for perturbing the input with Gaussian noise. Firstly, the Gaussian noise is added with uniform spatial distribution, i.e., all the pixels of the input get perturbed. Secondly, we randomly choose patches of different sizes centered at random locations in the input and add noise to only the locations within the patches. It was observed that the second approach yields better performance, since adding Gaussian noise in patches can break the spatial distribution of the adversarial perturbation. As adversarial perturbation is highly sensitive to spatial distribution, breaking the spatial correlation in such an adversarial example can bring the input back to the natural manifold. By adding noise in patches, stronger noise can be added to break the spatial correlation of the adversarial perturbation. Adding noise with identical power to every pixel pushes the input strongly towards OOD data, which even for samples from source distribution the de-noising autoencoder may not be able to recover. That is why it the second approach yields better performance.

After the addition of Gaussian noise in patches, the input x is transformed into \tilde{x} with a shift in the coordinate (r) on the manifold. If the process used to characterize the manifold at a coordinate point r is denoted by A(r) and the new coordinate after the perturbation is \tilde{r}, then A(r)≠A(\tilde{r}).

Step #2 Single Input De-noising Network—The perturbed input \tilde{x} is de-noised 104 with a small de-noising network. After this stage, the input transforms into x′. We point out that the de-noiser can function with different degrees and types of noise. Noise-to-noise mapping is used for de-noising \tilde{x} using a small single input de-noising network d_{ϕ}(.) parameterized by ϕ. To obtain two different noisy observation from the transformed input \tilde{x}, we down-sample it using two kernels, namely h₁(.)=[[0, 0.5], [0.5, 0]] and h₂(.)=[[0.5, 0], [0, 0.5]]. Finally, the de-noising network is optimized using the following loss:

$$ℒ ( ϕ ) = \frac{1}{2} ( {‖ {h}_{1} ( \tilde{x} ) - {d}_{ϕ} ( {h}_{1} ( \tilde{x} ) ) - {h}_{2} ( \tilde{x} ) ‖}_{2}^{2} + {‖ {h}_{2} ( \tilde{x} ) - {d}_{ϕ} ( {h}_{2} ( \tilde{x} ) - {h}_{1} ( \tilde{x} ) ‖}_{2}^{2} ) \qquad ( 2 )$$

After the denoising is performed, the noisy input i is transformed into x′ with coordinate r′ on the manifold. Here, ∥.∥ denotes L₂ norm.

Step #3: Laver-wise Gradient Projection Features—To characterize the manifold with gradients, we use the norm of the gradient of the loss function with respect to the DNN parameters. To utilize the additional information obtained through adding noise to the input, we observe that instead of capturing the characteristics of the manifold at a specific coordinate, we can capture the change in manifold characteristics A(r)−A(r′). To preserve both the direction and magnitude information, we use the norm of the projection of the gradient of x′ in the direction of the gradient of x.

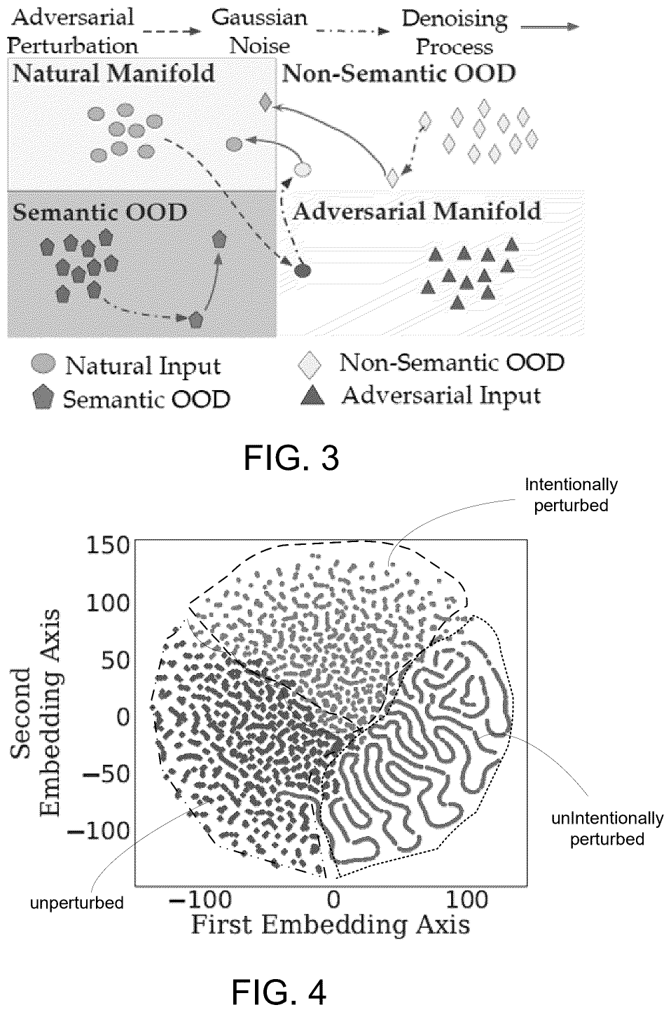

We define the parameter vector at layer l of our DNN as θ^{l}. As such, the gradient of the loss function L(θ, .) with respect to θ^{l} for input x is denoted by ∇_{θ}_{^{l}}L(x, θ). The gradient for x′ is ∇_{θ}_{^{l}}L(x′, θ). The change in manifold characteristics A(r)−A(r′) is then defined as

$$A ( r ) - A ( {r}^{′} ) = {‖ {∇}_{{θ}^{l}} ℒ ( {x}^{′} ; θ ) ‖}_{2} - \frac{〈 {∇}_{{θ}^{l}} ℒ ( x ; θ ) , {∇}_{{θ}^{l}} ℒ ( {x}^{′} ; θ ) 〉}{{‖ {∇}_{{θ}^{l}} ℒ ( {x}^{′} ; θ ) ‖}_{2}} . \qquad ( 3 )$$

Where <·, ·> denotes inner product between two vectors. The possible scenarios after de-noising are illustrated in FIG. 3 as follows:
1. r≈r′, which implies A(r)≈A(r′). This happens with high probability if X˜P_{source}, since perturbation and de-noising would cancel each other out;
2. r=r′+δ where δ captures the discrepancy between x and x′. This happens if X˜P_{adv} or X˜P_{non-semantic} since the input will be shifted toward the correct input on loss-manifold causing a difference in manifold characteristics for x and x′;
3. If x˜P_{semantic}, there is no perturbation involved since the input would appear from belonging to the source distribution. The difference in characteristics with ID samples is in A(r) itself as the DNN weights are not optimized for such input x. As such, we directly use A(r) to obtain the final score.

We extract 106 the gradient projection features from every layer of the DNN that has learnable parameters and concatenate them in a single vector f, thus forming he feature vector for the input x. By extracting the feature vectors for all the inputs in the training dataset, we obtain representation F∈ [symbol] ^{N}^{ₛ}^{×N}^{_{f}} that is expected to characterize the loss manifold. Here, Nₛ and N_{f} are the number of samples and the length of feature-vector f respectively. We then learn a score function from this representation.

Step #4: Learning a Score Function—Each sample fₓ∈F represents the manifold characteristics at different layers of DNN. A successful score function S(fₓ), needs that ∀x=X˜P_{source} ⇒S(fₓ)˜P_{source}^{S} and ∀x=X˜P_{ood} ⇒S(fₓ)˜P_{ood}^{S} subject to P_{source}^{S}(fₓ)<α. Here, α is a small positive constant that controls the FPR. We learn this score function from the representation F based on the assumption that feature vectors for inputs from the source dataset form high-density clusters. This is a reasonable assumption, since they share the same manifold in close proximity to each other. Although the straightforward approach would be to estimate the density of the feature vectors using Kernel Density Estimation (KDE), the high dimensionality of the feature vector poses challenges in the form of computation time and accuracy of the KDE due to the curse of dimensionality. Inspired by the Johnson-Lindenstrauss (JL) lemma, we project our feature vectors along random directions allowing us to perform the density estimation in lower dimensions and finally aggregate the resulting scores.

Lemma 1 (Johnson-Lindenstrauss lemma). If F=fᵢ₌₁^{i=N} is a set of N∈ [symbol] _{≥1} points in [symbol] ^{d}^{₁} (d₁∈ [symbol] _{≥0}), ε∈(0,1), and an integer

$${d}_{2} \geq \frac{8 ln ( N )}{ϵ} ,$$

there is a linear map K: [symbol] ^{d}^{₁}→ [symbol] ^{d}^{₂} such that (1−ϵ)∥fᵢ−|fⱼ∥²≤∥K(fᵢ)−K(fⱼ)∥²≤(1+ϵ)∥−∥² for all fᵢ, fⱼ∈F.

Algorithm 1 Learning Distribution of Features for Source Data

Input: Feature Matrix = F ∈ [symbol] ^{N}_{^{s}}^{×N}_{^{f}}

Number of Random Projections = K

Output: List of Kernel Density Estimators = EL

Random Projection Matrix = U ∈ [symbol] ^{N}_{^{f}}^{×K}

Procedure:

| | |
|---|---|
| 1: | EL ← [ ] //Initiating Empty List to Hold Kernel Density |
| | Estimators |
| 2: | U ← [ ] //Initiating Empty Matrix to Hold Random Direction |
| | Vectors |
| 3: | For k=1 to K |
| 4: | Sample a unit norm vector up and set k-th column of U to uk |
| 5: | F ← FU |
| 6: | For k=1 to K |
| 7: | Fit a univariate kernel density estimator to k-th column of F and |
| | append to EL |

Return EL, U

Algorithm 2 Extraction of Score S from feature vector f

| | |
|---|---|
| Input: | Feature Vector Corresponding to Test Input x = fₓ |
| | List of Trained Kernel Density Estimators = EL |
| | Random Projection Matrix = U ∈ [symbol] ^{N}_{^{f}}^{×K} |
| Output: | Score = S |

Procedure

| | |
|---|---|
| 1: | SL ← [ ] //Initiating Empty List to Hold Score Estimations |
| 2: | f ← fₓU |
| 3: | For k=1 to K |
| 4: | SL[k] ← Log-probability score for f[k] using EL[k] |
| 5: | μ ← Average of the scores in SL |
| 6: | q_{0.5} ← Median of the scores in SL |
| 7: | S ← 3q_{0.5} − 2μ |

Return S

The JL lemma states that there exist linear mappings in a lower dimension that preserves the distance between points up to some scaling factor. The preservation of distance between points will translate to preservation of density. With this intuition, we project 108 the feature matrix F in K random directions by multiplying it with a normalized projection matrix U∈ [symbol] ^{N}^{_{f×K}} and fit an independent kernel density estimator in each direction as shown in Algorithm 1. Along each direction, corresponding kernel density estimator provides a log-probability score for each input sample. The training phase consists of the fitting these density estimators on the source data. During test phase, we obtain the negative of the log-probability scores provided by density estimators. Then we estimate the most probable score as the mode of the score values using the approximate relation between mean(μ), median(q_{0.5}), and mode equal to 3q_{0.5}−2μ. This mode value or most probable score value 110 serves as the final score S for distinguishing our ID and OOD data samples. The steps for obtaining the score for individual samples are summarized in Algorithm 2. The final score value is compared 112 to a threshold t. If the final score value exceeds the threshold, the sample is determined to be a perturbed image. If the final score value does not exceed the threshold, the sample is determined to be an unperturbed image.

### Experimental Evaluation

### Experimental Setup

In-distribution Datasets. As our ID dataset, we use three commonly used benchmarks for OOD detection—CIFAR10 and CIFAR100 and ImageNet.

Out-of-distribution Datasets. To simulate unintentional perturbation or non-semantic shift in data, six types of noise are added to the input samples namely gaussian noise, impulse noise, defocus blur, shot noise, motion blur, and frost. The adversarial perturbations we consider are Basic Iterative Method (BIM)

$$( ϵ = \frac{8}{255} ) ,$$

Projected Gradient Descent (PGD)

$$( ϵ = \frac{4}{255} ) , Autoattack ( ϵ = \frac{8}{255} ) ,$$

and Carlini-Wagner (CW).

DNNs and Training Procedures. We have used ResNet56 and MobileNetV2(1.4) for CIFAR10 and CIFAR100. We use the pre-trained models from this repository to help making the results more reproducible. For experiments with ImageNet benchmark, we have used pretrained models from torch-hub. The models used for ImageNet benchmark are MobileNetV3(Large) and ResNet50.

Comparison Benchmarks. We consider MSP, Mahalanobis, Energy Based approach, ReAct, GradNorm, and ASH-B. To assess our performance in adversarial perturbation detection, we also consider some of the landmark papers in this domain. We consider the LID, Mahalanobis, Perturbed log-oods based approach, random subspace-based approach, and Halfspace Mass Depth Detector (HAMPER).

Quality of Features Visualization. In order to understand the quality of features extracted by FOOD, we show a visual example using T-distributed Stochastic Neighbor Embedding (TSNE) embeddings. Specifically, we extract features for 10,000 randomly selected samples from ImageNet. The samples are perturbed with PGD to simulate intentional perturbation and with shot noise to simulate unintentional perturbation. Next, we extract the gradient projection features from these three sample sets and extract their two-dimensional embedding. The resulting plot is shown in FIG. 4, which shows TSNE Visualization for unperturbed, intentionally perturbed and unintentionally perturbed inputs for Imagenet benchmark and Mobilenet V3 (Large) DNN. The groupings of points represent unperturbed, intentionally perturbed and unintentionally perturbed inputs as shown. The plot shows clear separation of perturbed inputs from un-perturbed ones which validates the quality of extracted features using FOOD. Intriguingly, the unperturbed inputs show slight overlap with unintentionally perturbed inputs while intentionally perturbed inputs are clearly separated. We attribute this behavior to the larger difference in manifold characteristics for unperturbed and intentionally perturbed inputs.

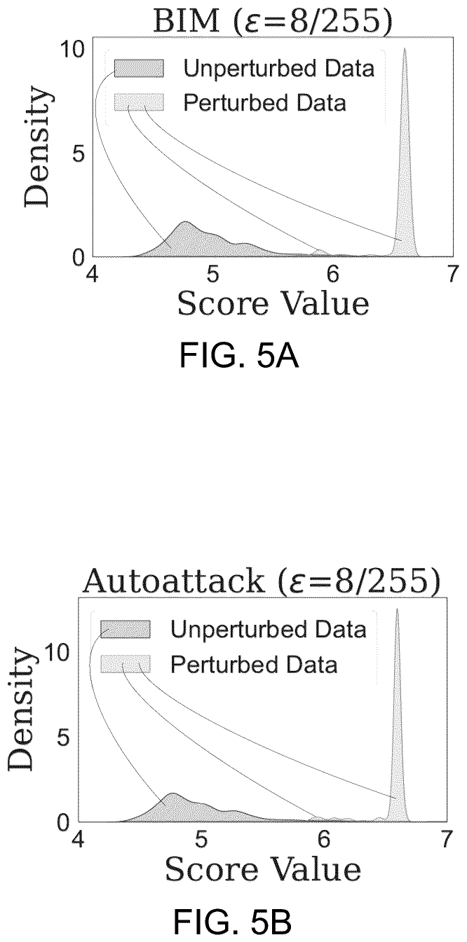

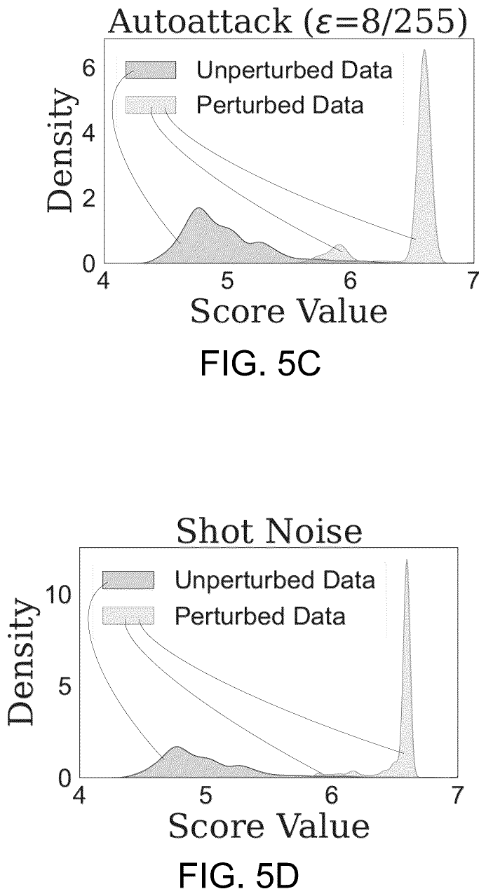

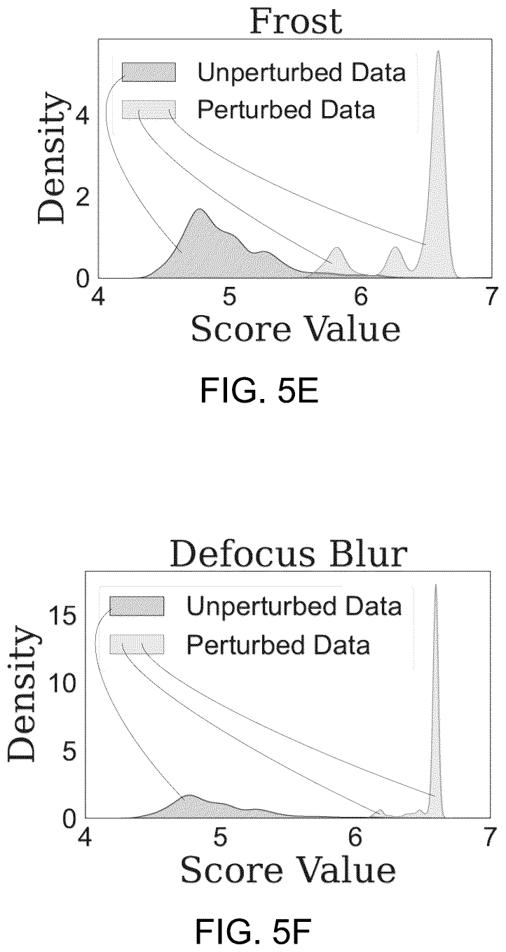

Results with Intentional Perturbation. FIG. 5 shows the probability density of scores in the case of CIFAR10 and ResNet56. We can see that FOOD is very effective at differentiating ID versus OOD inputs since the score clearly presents peaks corresponding to OOD inputs in all the considered cases. We compare the performance of our approach against different adversarial detection methods in Table 1, 2, and 3. We compare performance based on three metrics: (i) Area Under Receiver Operating Curve (AUROC), (ii) FPR, and (iii) Area Under Precision Recall Curve (AUPR). A higher value of AUROC and AUPR indicates better performance and a lower value of False Positive Rate at 95% True Positive Rate (FPR@95% TPR) represents superior performance. The results indicate that FOOD outperforms the existing approaches. For intentional perturbation detection on the CIFAR10 benchmark, our approach achieves average AUROC, FPR@95% TPR, and AUPR values of 99.32%, 1.71%, and 97.21% respectively which are 3.66%, 7.975%, and 1.37%. better than the second-best method HAMPER. Similarly, our approach beats the second-best methods by 5.59%, 14.61%, and 7.37% on CIFAR100 and by 0.39%, 5.29%, and −0.11% on ImageNet.

TABLE 1
Intentional perturbation detection performance on CIFAR10 dataset. The
values in the table denote % AUROC/% FPR@TPR95/% AUPR in the same order.

| | | BIM | PGD | Autoattack | CW |
|---|---|---|---|---|---|
| Architecture | Detector | (eps = 8/255) | (eps = 4/255) | (eps = 8/255) | (C = 0) |
| ResNet56 | LID | 5 [symbol] .2/40.3/53.2 | 56.2/ [symbol] 5.2/ [symbol] 0.0 | 51.8/45/48.5 | 53.2/38.3/ [symbol] |
| | Mahalanobis | 51.2/60.2/45.1 | [symbol] 0.3/43.1/ [symbol] 0. [symbol] | 48.5/49.3/45. [symbol] | 49/40.1/ [symbol] 6.5 |
| | Perturbed | 92.79/18.23/93.52 | 93.77/10.44/90.3 | 89.73/18. [symbol] 2/92.3 | 93. [symbol] 0/1 [symbol] .34/96.4 |
| | Log-odds | 92.4/3.2/88.4 | 89.6/3.8/86.3 | 87. [symbol] /4.5/84.65 | 94.1/2.4/ [symbol] 0. [symbol] |
| | Random | 97.0/1.5/92.4 | 97.5/3. [symbol] /9 [symbol] | 90.2 [symbol] /4.3/92.12 | 98.8/1.07/94.0 |
| | Subspace | 99.38/0.89/95 | 99.34/0.48/98.7 [symbol] | 99.26/2.32/94.71 | 99.43/0.52/98.33 |
| | HAMPER | | | | |
| | Ours | | | | |
| MobilenNetV2 | LID | 58. [symbol] /4 [symbol] .3/ [symbol] .5 | 5 [symbol] . [symbol] /42.1/49 2 | 55.3/45.2/54.5 | [symbol] /53.2/56.5 |
| (x1.4) | Mahalanobis | 52.7/43.2/50.5 | 60.8/36.1/53.5 | 56. [symbol] /42. [symbol] /38.5 | 50.3/36.1/53.5 |
| | Perturbed | 98.3/15.3/96.3 | 94.7/11.1/89.5 | 92.36/1 [symbol] .8/87.54 | 93.2/22/87.5 |
| | Log-odds | 91.37/52 15/9 [symbol] .12 | 9 [symbol] .65/30.80/92.13 | 90. [symbol] 6/35.59/97.64 | 92.62/33.68/98.27 |
| | Random | 92. [symbol] 2/15/98.27 | 98.35/18.20/99. [symbol] | [symbol] 9. [symbol] 9/13/97.30 | 94.24/20.2/98.67 |
| | Subspace | 99.42/2.44/98.38 | 99.4/2.53/99.18 | 98.83/3.04/94.12 | 90.48/1.44/99.25 |
| | HAMPER | | | | |
| | Ours | | | | |

[symbol]

indicates data missing or illegible when filed

TABLE 2
Intentional perturbation detection performance on CIFAR100 dataset. The
values in the table denote % AUROC/% FPR@TPR95/% AUPR in the same order.

| | | BIM | PGD | Autoattack | CW |
|---|---|---|---|---|---|
| Architecture | Detector | (eps = 8/255) | (eps = 4/255) | (eps = 8/255) | (C = 0) |
| ResNet [symbol] 0 | LID | 51.2/ [symbol] .3/43.2 | [symbol] 3.2/4 [symbol] .3/50.6 | [symbol] 2.0/ [symbol] / [symbol] 0.2 | [symbol] 2.2/54/50 |
| | Mahalanobis | 5056.85/46.3 | 49.2/50/ [symbol] .8 | 46.5/40/42.3 | 49/ [symbol] 2/48 |
| | Perturbed | 90.79/23.23/93.52 | 90.77/18.44/ [symbol] 6.3 | 87.73/20.7/86.3 | 96.80/16.34/93.4 |
| | Log-odds | 89.84/25 3 [symbol] /87.26 | 9 [symbol] /35.84/89. [symbol] | 84.03/54.41/73.1 | 86.76/42.36/76.32 |
| | Random | 97.97/10.17/ [symbol] | 95.8/18.5/ [symbol] 6.3 | 96.74/14.95/95. [symbol] | [symbol] 5.86/18.44/94.6 [symbol] |
| | Subspace | 97.55/0.0/99.8 [symbol] | 96.46/0.0/99.84 | 99.82/0.34/96.99 | 98.54/0.2/99.44 |
| | HAMPER | | | | |
| | Ours | | | | |
| MobilenNetV2 | LID | 4 [symbol] .3/4 [symbol] .1/4 [symbol] | 48.8/46.1/47.2 | 45.3/49/48.5 | 48.4/43.1/49. [symbol] |
| (x1.4) | Mahalanobis | 5 [symbol] .7/40.2/ [symbol] | [symbol] 8.3/40.1/57. [symbol] | [symbol] 1.3/45.1/ [symbol] | 38.3/34.1/59. [symbol] |
| | Perturbed | 98.3/5. [symbol] /9 [symbol] .3 | 94.7/14.1/89.5 | 92.3 [symbol] /13.69/87. [symbol] 4 | 93.2/1 [symbol] /87. [symbol] |
| | Log-odds | 86.4/4 [symbol] .2/84.9 | 83.3/45.7/77 | 78.7/3 [symbol] .6/ [symbol] 3.2 | 83.4/23.2/70 |
| | Random | 92.8/1 [symbol] /87.2 | [symbol] 4.3/14.3/90. [symbol] | 89.5/18.3/82.6 | [symbol] /16/ [symbol] .4 |
| | Subspace | 98.94/ [symbol] .92/ [symbol] .81 | 99.17/2.54/98.4 | 98.76/2.47/91.11 | 99.38/1. [symbol] 8/98.88 |
| | HAMPER | | | | |
| | Ours | | | | |

[symbol]

indicates data missing or illegible when filed

TABLE 3
Intentional perturbation detection performance on Imagenet1k dataset. The
values in the table denote % AUROC/% FPR@TPR95/% AUPR in the same order.

| | | BIM | PGD | Autoattack | CW |
|---|---|---|---|---|---|
| Architecture | Detector | (eps = 8/255) | (eps = 4/255) | (eps = 8/255) | (C = 0) |
| ResNet [symbol] 0 | LID | 46.2/78.4/49.6 | 45.3/76. [symbol] /49.4 | 44.5/77.9/49 | 4 [symbol] .4/7 [symbol] /3 [symbol] |
| | Mahalanobis | 48. [symbol] /7 [symbol] /46.5 | 47.5/79.6/43 | 43.1/85/42 | 47.3/7 [symbol] .3/47 |
| | Perturbed | 97 48/9/99.35 | 99.39/1.25/99.88 | 99.41/1.04/99. [symbol] | 99.32/1.67/99.86 |
| | Log-odds | 99.89/0.0/99. [symbol] 4 | 94.99/0.0/99. [symbol] 4 | 99.55/0.22/99.12 | 99.48/0.3/99. [symbol] 4 |
| | Ours | | | | |
| MobilenNetV3 | LID | 45.6/ [symbol] /48.2 | 49. [symbol] /78.4/ [symbol] 2.1 | 43.2/88.4/38. [symbol] | 4 [symbol] / [symbol] /48.4 |
| | Mahalanobis | 40.3/84.5/4 [symbol] .6 | 47.4/80.6/40.5 | 41.0/80.5/44 | 42.4/88/43 6 |
| | Perturbed | 96.16/19. [symbol] 7/99. [symbol] | 97.73/4 [symbol] /99.74 | 98.94/ [symbol] /99.70 | 99.49/2.89/99.1 [symbol] |
| | Log-odds | 98.71/0.96/98.94 | 99.5/0.06/99.89 | 99.85/0.04/99.91 | 99.14/0.92/99.03 |
| | Ours | | | | |

[symbol]

indicates data missing or illegible when filed

TABLE 4
Comparison of results on CIFAR10 benchmark. The metrics
are AU-ROC/FPR@95% TPR/AUPR in the order mentioned here.

| Architecture | Detector | Gaussian noise | Impulse Noise | Defocus Blur | Shot Noise | Motion Blur | Frost |
|---|---|---|---|---|---|---|---|
| ResNet56 | MSP | 3.43/97.2/5.72 | 3.4/97/4.5 | 1.7/9.0/78.7 | 3.4/97.4/0.1 | 1.3/45.7/63.4 | 0.1/87/4.7 |
| | Energy | 82.2/49/71.6 | 82.5/47.5/72 | 98.9/2.3/97.5 | 80/57.8/70.6 | 95.0/17.9/95.6 | 80.8/73/80.4 |
| | Score | | | | | | |
| | ReAct | 70.2/73.2/62.9 | 70/73.5/62.8 | 98.2/4.7/96.5 | 66.1/79.8/61 | 92.3/40.6/93 | 77.4/80/78.3 |
| | Grad | 76.4/70.2/60.5 | 76.5/54.3/68.6 | 92.1/30.2/93.2 | 65.4/90.2/68.4 | 94.5/16.2/96.6 | 70.1/57.5/73.6 |
| | Norm | | | | | | |
| | Ash-B | 74.6/75.1/73.2 | 72.7/78.5/71.9 | 92/34/90.6 | 69.8/87.1/70 | 80.3/56.4/90.7 | 72.0/50.4/75.8 |
| | Ours | 99.2/1.2/98.1 | 99.2/0.7/98.2 | 99.3/0.7/97.8 | 99.2/1.2/98.1 | 99.1/1.7/98 | 98.8/3.7/98.2 |
| MobileNet | MSP | 10/94.4/14.4 | 10.5/93.0/10.7 | 0.6/1.3/99.2 | 0.2/95.8/18.7 | 3.8/19.7/83.4 | 6/95/3.2 |
| V2(x1.4) | Energy | 73.7/53.7/61.7 | 70.5/59.8/59.1 | 99.6/1.7/99.4 | 77.2/49.9/65.7 | 95.2/20.2/94.7 | 79/84.5/80.6 |
| | Score | | | | | | |
| | ReAct | 51.4/74.4/45.4 | 54/71.1/46.9 | 99.3/2.8/99.1 | 47.1/82.3/43.5 | 91.7/41.1/91.6 | 74.2/80.6/75.1 |
| | Grad | 55.2/64.3/60.2 | 53.6/70.3/47.2 | 95.3/3.2/98.5 | 48.1/80.8/44.5 | 91.4/38.2/93.6 | 79/62.5/76 |
| | Norm | | | | | | |
| | Ash-B | 54.1/65.4/46.7 | 56.8/70.3/47.2 | 93.4/18.8/91.3 | 56.3/80.8/44.5 | 81.2/54.4/75.7 | 62.8/87.6/59.4 |
| | Ours | 98.4/2.4/95.7 | 98.8/2.5/95.6 | 99.6/0.5/99.6 | 98.8/2.5/97.1 | 99.5/1.1/99.4 | 99.4/2.4/99.3 |

TABLE 5
Comparison of results on CIFAR100 benchmark. The metrics
are AU-ROC/FPR@95% TPR/AUPR in the order mentioned here,

| Architecture | Detector | Gaussian noise | Impulse Noise | Defocus Blur | Shot Noise | Motion Blur | Frost |
|---|---|---|---|---|---|---|---|
| ResNet56 | MSP | 15.32/26.1/72.9 | 12.4/33.9/64.2 | 18.5/20.3/81.4 | 15.7/25.5/73.9 | 22.2/35.9/81.8 | 4.6/88.3/18.3 |
| | Energy | 74.8/45/61.4 | 70.2/52.5/57.6 | 65.9/65.8/54 | 73.1/48.4/66.1 | 62.3/79.9/55.2 | 72.3/75.7/68.4 |
| | Score | | | | | | |
| | ReAct | 72.5/43.7/59.2 | 69.5/48.3/56.8 | 83.2/46.7/77.0 | 69.3/46.1/56.4 | 81.2/54.7/76.7 | 72.1/73.5/68.7 |
| | Grad | 54.6/47.9/80 | 83.1/54.0/76.6 | 92.8/24.9/92.7 | 82.2/57.5/73.5 | 80.6/44.1/84.7 | 76.8/70/75 |
| | Norm | | | | | | |
| | Ash-B | 85.0/48.0/79.5 | 82.1/55.4/75.6 | 92.8/24.9/92.7 | 81.2/56.5/74.8 | 80.6/45.1/84.7 | 74.8/72.5/72 |
| | Ours | 99.5/1/98.7 | 99.5/0.8/98.9 | 99.9/0.8/98.9 | 99.4/1.5/98.4 | 99.5/1.5/98.9 | 98.8/3.5/98 |
| MobileNst | MSP | 20.6/8.5/87.5 | 19.4/10.8/85 | 19.6/19.5/91.5 | 20.6/10.5/88.3 | 19.9/20.2/90 | 5/79.9/22.3 |
| V2(x1.4) | Energy | 94.1/13.3/88.3 | 93.2/16.3/87.4 | 70.5/66.4/65 | 94.3/14.3/89 | 65.7/77.7/60.0 | 79.9/61.7/76.7 |
| | Scors | | | | | | |
| | ReAct | 94.1/14.1/88.8 | 93.3/17.4/87.9 | 70.2/66/66.3 | 94.0/14.1/96.1 | 69.9/76.9/65.4 | 80.7/61.6/78 |
| | Grad | 95.1/13.4/55.3 | 95.2/15.3/86.4 | 72.5/67.4/64.7 | 93.3/12.3/96.5 | 68.7/74.7/62.5 | 82.9/62.7/75.7 |
| | Norm | | | | | | |
| | Ash-B | 98.3/5.5/85.3 | 97.4/8.7/96.0 | 86.3/30/79.9 | 98.1/7/97.4 | 73.1/73/68.7 | 73/73/72.4 |
| | Ours | 99.5/0.4/98.8 | 99.5/0.4/98.8 | 99.5/0.4/99.4 | 99.5/0.4/99.3 | 99.5/1/99 | 98.9/4.2/98.4 |

TABLE 6
Comparison of results on Imagenet benchmark. The metrics
are AU-ROC/FPR@95% TPR/AUPR in the order mentioned here.

| Architecture | Detector | Gaussian noise | Impulse Noise | Defocus Blur | Shot Noise | Motion Blur | Frost |
|---|---|---|---|---|---|---|---|
| ResNet56 | MSP | 16.7/40.55/42.6 | 13.5/55.6/43.2 | 21.5/45.9/70 | 16.3/55/56.4 | 25.6/45.2/80.4 | 6.2/90.1/25 |
| | Energy | 99.1/3.5/99.1 | 98.9/4.7/98.9 | 97.5/12.8/97.6 | 98.8/4.7/98.9 | 97/14.9/97.2 | 93.9/32.5/94.3 |
| | Score | | | | | | |
| | ReAct | 98.7/6.9/98.7 | 98.1/7.6/7.8 | 95.3/16/92.8 | 97.7/9.1/97.4 | 94.9/29.5/93.9 | 90.8/43.5/89.9 |
| | Grad | 93.2/14.3/88.3 | 94.2/15.4/88.4 | 74.5/62.4/64 | 93.3/16.3/87.5 | 61.7/79.7/60.6 | 77/63.7/74.7 |
| | Norm | | | | | | |
| | Ash-B | 99.4/1.7/99.4 | 98.9/4.9/98.8 | 98.1/0.9/98.2 | 98.5/6.9/98.4 | 97.9/11/97.9 | 94.7/27.2/94.9 |
| | Ours | 99.5/1.7/99.3 | 99.4/1.7/99.2 | 99.4/1.7/99.3 | 99.2/1.8/99.2 | 99.1/2.7/99 | 99.3/2.5/99.2 |
| MobileNst | MSP | 15.3/50.2/46.3 | 16.5/52.4/42 | 20.4/55.6/76 | 12.3/58/48.6 | 27/42/75.2 | 2.5/91.2/22.5 |
| V3(Large) | Energy | 99.1/2.9/98.7 | 98.9/3.5/98.5 | 97.8/7.1/96 | 98.7/4.5/98.2 | 97.5/9/96.6 | 94.1/27.2/93.1 |
| | Score | | | | | | |
| | ReAct | 98.4/5.8/98.3 | 98.1/7.6/7.8 | 95.3/16/92.8 | 97.7/9.1/97.4 | 94.9/26.5/93.9 | 90.5/43.5/89.9 |
| | Grad | 85.92/48.07/70.52 | 85.1/51.4/73.6 | 96.8/27.9/91.7 | 56.2/52/71.8 | 87.6/45.6/81.7 | 72.8/72.5/72 |
| | Norm | | | | | | |
| | Ash-B | 99.2/2.3/62.7 | 99.1/2.7/68.2 | 98.6/4.3/74.7 | 98.9/3.2/69 | 97.9/5.5/94 | 94.4/21.6/91.6 |
| | Ours | 98.3/1.3/97.9 | 98.7/1.3/99.1 | 99/1.3/99.3 | 99.1/1.1/99.7 | 99.6/2.3/99.6 | 99/2.5/99.2 |

Results with Unintentional Perturbation. As with intentional perturbations, FOOD exhibits superior performance in detecting non-semantic OOD, as shown in the density plot of FIG. 5 and AUROC, FPR@95% TPR, and AUPR values shown in Tables 4, 5, and 6. Table 4 shows a comparison of results on CIFAR10 benchmark. Table 5 shows a comparison of results on CIFAR100 benchmark. Table 6 shows a comparison of results on Imagenet benchmark. Specifically, FOOD outperforms the second-best method by 15%, 38%, and 18.85% on CIFAR10 in terms of AUROC, FPR@95% TPR, and AUPR respectively. Likewise, it improves the state-of-the-art in terms of the mentioned metrics by 13.48%, 40.33%, and 16.28% for CIFAR100 benchmark and by 1.14%, 6.59%, and 11.86% for ImageNet.

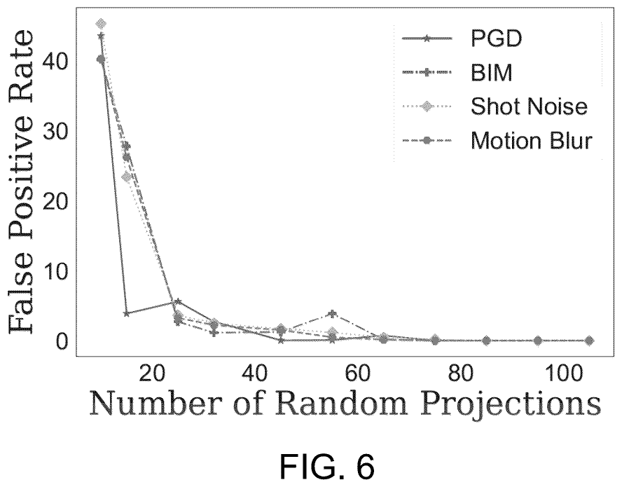

Effect of the Number of Random Directions for Projection. One key aspect of FOOD is the detection of perturbed input via kernel density estimation in lower dimensions. As projection in random directions is used to achieve a low-dimensional representation, one key hyper-parameter is the number of directions to use for random projection. As such, we change the number of projections from 10% to 100% of the dimension of the feature. FIG. 6 shows that the FPR stabilizes around about 70% of the feature-length N_{f}. In our experiments, we set the number of random projections to 70% of the feature length.

Detection of OOD is a stark and fundamental problem in machine learning, as DNNs are known to exhibit loss of performance in the presence of OOD inputs. The embodiments described herein address OOD due to semantic shift (due to the presence of a new class), non-semantic shift (due to unintentional perturbations) and intentional perturbation (due to adversarial inputs). Prior work did not propose a comprehensive framework detecting the three types of OOD inputs at once. As such, in this paper we have proposed FOOD, a Framework for Out-of-distribution Detection. We have based FOOD upon the intuition that perturbation to inputs can be detected based on the change in the characteristics of the loss manifold due to perturbation. To validate the performance of FOOD, we have performed an extensive experimental campaign on well-known DNN and dataset benchmarks. We have shown that in the case of intentional perturbation detection, FOOD outperforms the state-of-the-art approaches in terms of FPR by 7.97% on CIFAR10, 14.61% on CIFAR100, and 5.29% on ImageNet, and by 41.38% on CIFAR10 and 40.3375% on CIFAR100 and 6.59% on ImageNet in the case of unintentional perturbations.

It will be apparent that one or more embodiments described herein may be implemented in many different forms of software and hardware. Software code and/or specialized hardware used to implement embodiments described herein is not limiting of the embodiments of the invention described herein. Thus, the operation and behavior of embodiments are described without reference to specific software code and/or specialized hardware—it being understood that one would be able to design software and/or hardware to implement the embodiments based on the description herein.

Further, certain embodiments of the example embodiments described herein may be implemented as logic that performs one or more functions. This logic may be hardware-based, software-based, or a combination of hardware-based and software-based. Some or all of the logic may be stored on one or more tangible, non-transitory, computer-readable storage media and may include computer-executable instructions that may be executed by a controller or processor. The computer-executable instructions may include instructions that implement one or more embodiments of the invention. The tangible, non-transitory, computer-readable storage media may be volatile or non-volatile and may include, for example, flash memories, dynamic memories, removable disks, and non-removable disks.

While example embodiments have been particularly shown and described, it will be understood by those skilled in the art that various changes in form and details may be made therein without departing from the scope of the embodiments encompassed by the appended claims.

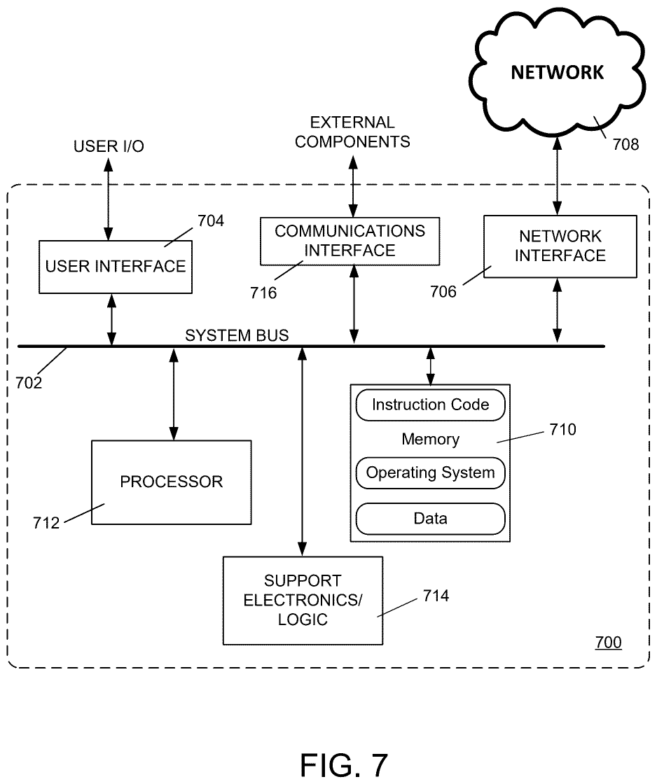

FIG. 7 is a diagram of an example internal structure of a processing system 700 that may be used to implement one or more of the embodiments herein. Each processing system 700 contains a system bus 702, where a bus is a set of hardware lines used for data transfer among the components of a computer or processing system. The system bus 702 is essentially a shared conduit that connects different components of a processing system (e.g., processor, disk storage, memory, input/output ports, network ports, etc.) that enables the transfer of information between the components.

Attached to the system bus 702 is a user I/O device interface 704 for connecting various input and output devices (e.g., keyboard, mouse, displays, printers, speakers, etc.) to the processing system 700. A network interface 706 allows the computer to connect to various other devices attached to a network 708. Memory 710 provides volatile and non-volatile storage for information such as computer software instructions used to implement one or more of the embodiments of the present invention described herein, for data generated internally and for data received from sources external to the processing system 700.

A central processor unit 712 is also attached to the system bus 702 and provides for the execution of computer instructions stored in memory 710. The system may also include support electronics/logic 714, and a communications interface 716.

In one embodiment, the information stored in memory 710 may comprise a computer program product, such that the memory 710 may comprise a non-transitory computer-readable medium (e.g., a removable storage medium such as one or more SSDs, DVD-ROM's, CD-ROM's, diskettes, tapes, etc.) that provides at least a portion of the software instructions for the invention system. The computer program product can be installed by any suitable software installation procedure, as is well known in the art. In another embodiment, at least a portion of the software instructions may also be downloaded over a cable communication and/or wireless connection.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed or contemplated herein or in the manuscript being filed herewith.

What is claimed is:

1. A method of detecting an out-of-distribution input to a deep neural network (DNN), comprising:
perturbing a sample input to produce a perturbed sample input;
de-noising the perturbed sample input to produce a de-noised sample input;
extracting one or more gradient projection features of the sample input from each layer of the DNN, and concatenating the one or more gradient projection features of the sample input from the layers of the DNN into a single feature vector for the sample input;
extracting one or more gradient projection features of the de-noised sample input from each layer of the DNN, and concatenating the one or more gradient projection features of the de-noised sample input from the layers of the DNN into a single feature vector for the denoised sample input;
generating a projected density score based on the single feature vector for the sample input and the single feature vector the de-noised sample input; and
determining that the sample input is out-of-distribution when the projected density score exceeds a threshold.

2. The method of claim 1, further comprising perturbing the sample input with additive Gaussian noise.

3. The method of claim 2, wherein the additive Gaussian noise has a mean of zero and a 0.1 deviation.

4. The method of claim 1, further comprising randomly choosing patches of different sizes, centered at random locations in the input, and perturbing the sample input by adding Gaussian noise to only the locations within the patches.

5. The method of claim 1, further comprising de-noising the perturbed sample input by using noise-to-noise mapping.

6. The method of claim 1, further comprising de-noising the perturbed sample input by obtaining two kernels of h₁(.)=[[0, 0.5], [0.5, 0]] and h₂(.)=[[0, 0.5], [0.5, 0]], and optimizing the loss of
$$ℒ ( ϕ ) = \frac{1}{2} ( {‖ {h}_{1} ( \tilde{x} ) - {d}_{ϕ} ( {h}_{1} ( \tilde{x} ) ) - {h}_{2} ( \tilde{x} ) ‖}_{2}^{2} + {‖ {h}_{2} ( \tilde{x} ) - {d}_{ϕ} ( {h}_{2} ( \tilde{x} ) - {h}_{1} ( \tilde{x} ) ‖}_{2}^{2} ) .$$

7. The method of claim 1, further comprising generating a projected density score by projecting each of the feature vector for the sample input and the feature vector for the de-noised sample input along a random direction, and performing a density estimation in lower dimensions.

8. A system for detecting an out-of-distribution input to a deep neural network (DNN), comprising:
a processor; and
a memory with computer code instructions stored thereon, the memory operatively coupled to the processor such that, when executed by the processor, the computer code instructions cause the system to:
perturb a sample input to produce a perturbed sample input;
de-noise the perturbed sample input to produce a de-noised sample input;
extract one or more gradient projection features of the sample input from each layer of the DNN, and concatenate the one or more gradient projection features of the sample input from the layers of the DNN into a single feature vector for the sample input;
extract one or more gradient projection features of the de-noised sample input from each layer of the DNN, and concatenate the one or more gradient projection features of the de-noised sample input from the layers of the DNN into a single feature vector for the denoised sample input;
generate a projected density score based on the single feature vector for the sample input and the single feature vector the de-noised sample input; and
determine that the sample input is out-of-distribution when the projected density score exceeds a threshold.

9. The system of claim 8, wherein the sample input is perturbed with additive Gaussian noise.

10. The system of claim 9, wherein the additive Gaussian noise has a mean of zero and a 0.1 deviation.

11. The system of claim 8, wherein the computer code instructions further cause the system to randomly choose patches of different sizes, centered at random locations in the input, and perturb the sample input by adding Gaussian noise to only the locations within the patches.

12. The system of claim 8, wherein the computer code instructions further cause the system to de-noise the perturbed sample input through noise-to-noise mapping.

13. The system of claim 8, wherein the computer code instructions further cause the system to generate a projected density score by projecting each of the feature vector for the sample input and the feature vector for the de-noised sample input along a random direction, and performing a density estimation in lower dimensions.

14. The system of claim 8, wherein the computer code instructions further cause the system to de-noise the perturbed sample input by obtaining two kernels of h₁(.)=[[0, 0.5], [0.5, 0]] and h₂(.)=[[0, 0.5], [0.5, 0]], and optimize the loss of
$$ℒ ( ϕ ) = \frac{1}{2} ( {‖ {h}_{1} ( \tilde{x} ) - {d}_{ϕ} ( {h}_{1} ( \tilde{x} ) ) - {h}_{2} ( \tilde{x} ) ‖}_{2}^{2} + {‖ {h}_{2} ( \tilde{x} ) - {d}_{ϕ} ( {h}_{2} ( \tilde{x} ) - {h}_{1} ( \tilde{x} ) ‖}_{2}^{2} ) .$$

15. A non-transitory computer-readable medium with computer code instruction stored thereon, the computer code instructions, when executed by a processor, cause an apparatus to:
perturb a sample input to produce a perturbed sample input;
de-noise the perturbed sample input to produce a de-noised sample input;
extract one or more gradient projection features of the sample input from each layer of the DNN, and concatenate the one or more gradient projection features of the sample input from the layers of the DNN into a single feature vector for the sample input;
extract one or more gradient projection features of the de-noised sample input from each layer of the DNN, and concatenate the one or more gradient projection features of the de-noised sample input from the layers of the DNN into a single feature vector for the denoised sample input;
generate a projected density score based on the single feature vector for the sample input and the single feature vector the de-noised sample input; and
determine that the sample input is out-of-distribution when the projected density score exceeds a threshold.

16. The non-transitory computer-readable medium of claim 15, wherein the computer code instructions, when executed by the processor, further cause an apparatus to generate a projected density score by projecting each of the feature vector for the sample input and the feature vector for the de-noised sample input along a random direction, and performing a density estimation in lower dimensions.

17. The non-transitory computer-readable medium of claim 15, wherein the computer code instructions, when executed by the processor, further cause an apparatus to de-noise the perturbed sample input by obtaining two kernels of h₁(.)=[[0, 0.5], [0.5, 0]] and h₂(.)=[[0, 0.5], [0.5, 0]], and optimize the loss of
$$ℒ ( ϕ ) = \frac{1}{2} ( {‖ {h}_{1} ( \tilde{x} ) - {d}_{ϕ} ( {h}_{1} ( \tilde{x} ) ) - {h}_{2} ( \tilde{x} ) ‖}_{2}^{2} + {‖ {h}_{2} ( \tilde{x} ) - {d}_{ϕ} ( {h}_{2} ( \tilde{x} ) - {h}_{1} ( \tilde{x} ) ‖}_{2}^{2} ) .$$

18. The non-transitory computer-readable medium of claim 15, wherein the computer code instructions, when executed by the processor, further cause an apparatus to randomly choose patches of different sizes, centered at random locations in the input, and perturb the sample input by adding Gaussian noise to only the locations within the patches.
